(19) United States
(12) Patent Application Publication
(10) Pub. No.: US 2026/0289545 A1
(43) Pub. Date: Sep. 24, 2026

(54) ADAPTIVE SYSTEM FOR DETERMINING AND PRESENTING DIGITAL EMULATED CARDS

(71) Applicant: STMicroelectronics (Beijing) R&D Co. Ltd, Beijing (CN)

(72) Inventor: Qinglei LI, Beijing (CN)

(73) Assignee: STMicroelectronics (Beijing) R&D Co. Ltd, Beijing (CN)

(21) Appl. No.: 19/473,370

(22) PCT Filed: Apr. 14, 2023
(86) PCT No.: PCT/CN2023/088485

§ 371 Date: Oct. 7, 2025

(51) Int. Cl. G06Q 20/32; G06K 7/10; G06K 19/07

(52) U.S. Cl. CPC G06Q 20/3278; G06K 7/10297; G06K 19/0723

(57) ABSTRACT

Responsive to a request for presenting a digital emulated card, a near field communication (NFC) device collects a current time, a current location of the NFC device, and current radio frequency (RF) data associated with an NFC reader. A first candidate card is determined from a plurality of digital emulated cards stored on the NFC device based on the current time and current location, and a second candidate card based on the current RF data. A target digital emulated card is determined based on the first and second candidate cards, and is presented, by the NFC device, to the NFC reader via NFC communication.

### BACKGROUND

### Technical Field

The present disclosure relates to the field of near field communication (NFC). The present disclosure relates more particularly to selecting digital emulated cards for NFC communication.

### Description of the Related Art

NFC technology utilizes radiofrequency signals to enable devices to communicate with each other in close proximity. Many applications of NFC technology utilize an NFC reader to interrogate and receive data from an NFC device. The NFC reader typically outputs an interrogation signal. If an NFC device is within range of the interrogation signal, then the NFC device responds by providing an identification signal identifying the NFC device. After the NFC device has identified itself, the NFC reader and the NFC device can further exchange information.

One type of NFC device is a mobile phone with NFC capabilities. The mobile phone can store digital emulated card data for a plurality of NFC cards. One may indifferently refer to digital emulated card or emulated cards hereinafter. The emulated cards can include emulated access cards that grant access to a building, a room, or other types of locations. The emulated cards can include emulated transit cards that grant access to transit services such as municipal trains, busses, or other types of transit services. The emulated cards can include emulated banking cards corresponding to debit cards, credit cards, or other types of financial transaction cards. In these cases, a user does not carry physical NFC cards, but rather the mobile phone stores data related to one or more NFC cards. When a user approaches an access point, the user can present the mobile phone to the NFC reader. The mobile phone communicates with the NFC reader and presents the digital emulated card data to the NFC reader.

In some cases, a mobile phone, or other type of NFC device, may store digital emulated card data for a large number of emulated cards. In these cases, it can be cumbersome to present the correct digital emulated card data from the mobile phone to an NFC reader at an access point.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

Embodiments of the present disclosure provide a method, including: responsive to a request for presenting a digital emulated card, collecting, by a near field communication (NFC) device, a current time, a current location of the NFC device, and current radio frequency (RF) data associated with an NFC reader; determining a first candidate digital emulated card from a plurality of digital emulated cards stored on the NFC device based, at least in part, on the current time and current location; determining a second candidate digital emulated card from the plurality of digital emulated cards based, at least in part, on the current RF data; determining a target digital emulated card based, at least in part, on the first and second candidate digital emulated cards; and presenting, by the NFC device, the target digital emulated card to the NFC reader via NFC communication.

Embodiments of the present disclosure provide an NFC device that includes one or more processors, and memory storing contents that, when executed by the one or more processors, cause the NFC device to perform actions. The actions include: responsive to a request for presenting a digital emulated card, collecting a current time, a current location of the NFC device, and current radio frequency (RF) data associated with an NFC reader; determining a first candidate digital emulated card from a plurality of digital emulated cards stored on the NFC device based, at least in part, on the current time and current location; determining a second candidate digital emulated card from the plurality of digital emulated cards based, at least in part, on the current RF data; determining a target digital emulated card based, at least in part, on the first and second candidate digital emulated cards; and presenting the target digital emulated card to the NFC reader via NFC communication.

Embodiments of the present disclosure provide a non-transitory computer-readable medium storing contents that cause one or more processors to perform actions.

The actions include: responsive to a request for presenting a digital emulated card, collecting, by a near field communication (NFC) device, a current time, a current location of the NFC device, and current radio frequency (RF) data associated with an NFC reader; determining a first candidate digital emulated card from a plurality of digital emulated cards stored on the NFC device based, at least in part, on the current time and current location; determining a second candidate digital emulated card from the plurality of digital emulated cards based, at least in part, on the current RF data; determining a target digital emulated card based, at least in part, on the first and second candidate digital emulated cards; and presenting, by the NFC device, the target digital emulated card to the NFC reader via NFC communication.

Embodiments of the present disclosure provide an NFC system that includes one or more host processors, and an NFC device coupled to the one or more host processors and configured to perform actions. The actions include: responsive to a request for presenting a digital emulated card, collecting a current time, a current location of the NFC device, and current radio frequency (RF) data associated with an NFC reader; determining a first candidate digital emulated card from a plurality of digital emulated cards stored on the NFC device based, at least in part, on the current time and current location; determining a second candidate digital emulated card from the plurality of digital emulated cards based, at least in part, on the current RF data; determining a target digital emulated card based, at least in part, on the first and second candidate digital emulated cards; and presenting the target digital emulated card to the NFC reader via NFC communication.

### BRIEF DESCRIPTION OF THE SEVERAL VIEWS OF THE DRAWINGS

FIG. 1 is a block diagram of an NFC system, according to some embodiments.

FIG. 2 illustrates a flow diagram of an example process for determining and presenting digital emulated card, according to some embodiments.

FIG. 3 illustrates a flow diagram of an example process for determining a target emulated card for a new NFC card transaction, according to some embodiments.

FIG. 4 is a block diagram illustrating elements of an example computing device or system utilized according to some embodiments.

FIG. 5 illustrates an example of historical transaction data.

FIG. 6 illustrates the period of each polling loop from a particular NFC reader that sends polling event periodically, according to some embodiments.

FIG. 7 illustrates the period of each polling command from a particular NFC reader, according to some embodiments.

### DETAILED DESCRIPTION

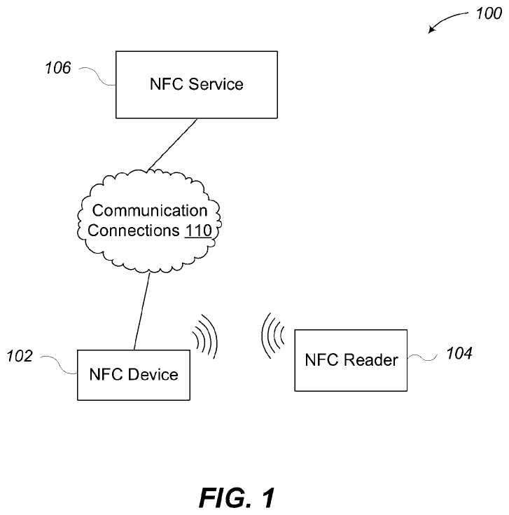

FIG. 1 is a block diagram of an NFC system 100, according to some embodiments. The NFC system 100 includes an NFC device 102 and an NFC reader 104.

The NFC device 102 and the NFC reader 104 communicate with each other utilizing NFC technology. The NFC reader 104 enables a type of transaction when presented with a digital emulated card that matches the reader.

In some embodiments, the NFC reader 104 grants access to a location or service. For example, the NFC reader 104 may control access to enter a building or to enter an area within a building. The NFC reader 104 may be communicatively coupled to a locking mechanism on the door. The NFC reader 104 may be configured to establish communication with an NFC device 102, to receive digital emulated card data from the NFC device 102, and to cause the locking mechanism to unlock the door or to otherwise open the door if a valid digital emulated card is presented. This can enable a user of the NFC device 102 to enter a building or room within a building.

In some embodiments, the NFC reader 104 may control access to a transportation service. For example, the NFC reader 104 may be positioned at an entry to a subway, train, bus, or other transportation service at a particular region. The NFC reader may be configured to establish NFC communication with an NFC device, to receive digital emulated card data from the NFC device 102, and to grant access to the transportation service if the NFC device 102 presents a valid emulated card.

In some embodiments, the NFC reader 104 may control payment transactions for goods or services. For example, the NFC reader 104 may be positioned at a payment location of a store or other location that may process payment for goods or services. The NFC reader may be configured to establish NFC communication with an NFC device, to receive digital emulated card data from the NFC device 102, and to process payment for goods or services if the NFC device 102 presents a valid emulated card. In these cases, the emulated card may correspond to a debit card, a credit card, a rewards card, or other type of financial transaction card. Accordingly, in some embodiments the NFC device 102 may store emulated card data for ticketing, payment, access control, or other types of actions. The emulated card data can include emulated cards for any service or secure area such as homes, automobiles, hotels, workplaces, etc.

An NFC device 102, such as a smart phone, smart watch, tablet computer, or other portable computing device, may store digital emulated card data for a large number of emulated cards for a user. For example, the NFC device 102 may store digital emulated cards for a user's apartment building, a user's employment building, a hotel room, train services in different regions, bus services different regions, and for various other locations or services. Each time the NFC device 102 is presented to an NFC reader 104, the user will not be granted access until the proper digital emulated card is presented. As used herein, “proper digital emulated card,” “correct digital emulated card,” or similar terms for an NFC reader can correspond to the emulated card associated with the NFC reader and configured to authorize a transaction or action (such as granting access, transacting payment, etc.).

In some embodiments, an NFC device 102 may communicate with one or more NFC services 106 via communication connections 110. The communication connections 110 may include one or more computer networks, one or more wired or wireless networks, satellite transmission media, one or more cellular networks, or some combination thereof. The communication connections 110 may include a publicly accessible network of linked networks, possibly operated by various distinct parties, such as the Internet. The communication connections 110 may include other network types, such as one or more private networks (e.g., corporate or university networks that are wholly or partially inaccessible to non-privileged users), and may include combinations thereof, such that (for example) one or more of the private networks have access to and/or from one or more of the public networks. Furthermore, the communication connections 110 may include various types of wired and/or wireless networks in various situations, including satellite transmission. In addition, the communication connections 110 may include one or more communication interfaces including radio frequency (RF) transceivers, cellular communication interfaces and antennas, USB interfaces, ports and connections (e.g., USB Type-A, USB Type-B, USB Type-C (or USB-C), USB mini A, USB mini B, USB micro A, USB micro C), other RF transceivers (e.g., infrared transceivers, Zigbee® network connection interfaces based on the IEEE 802.15.4 specification, Z-Wave® connection interfaces, wireless Ethernet (“Wi-Fi”) interfaces, short range wireless (e.g., Bluetooth®) interfaces or the like.

In some embodiments, the NFC service 106 can be a cloud-based or otherwise implemented in a software and/or hardware form on one or more remote computing devices including a computer, mobile device, tablet computer, smart phone, handheld computer, and/or workstation, etc. The NFC device 102 may or may not interact with the NFC device 106 in the determination and presentation of digital emulated cards.

One typical solution for the NFC device 102 is to sequentially present digital emulated cards to an NFC reader 104 until the correct digital emulated card is presented and access is granted. One drawback of this solution is that a large amount of time may be consumed before the correct digital emulated card is presented, thus the real-time or near real-time efficiency required for certain transactions cannot be achieved. For example, if a user stores in the NFC device 102 ten different digital emulated cards for various locations and/or services, then in a worst-case scenario the NFC device 102 may only present the correct digital emulated card after presenting the nine incorrect digital emulated cards. This can be impractical for NFC card usage in many circumstances (e.g., causing a long queue or other backlog to go into a subway, bus, gate, or the like).

Another factor that may further increase the amount of time that elapses before a correct card is presented is that, in some embodiments, once the NFC device 102 presents data to the NFC reader 104, the behavior of the NFC reader 104 changes from a polling or interrogation mode to a communication mode. A relatively large amount of time may elapse before the NFC reader 104 reverts to a polling mode to enable the NFC device 102 to present the next emulated card. In at least these contexts, various embodiments of the presently disclosed technology are directed to the efficient determination and presentation of proper digital emulated card.

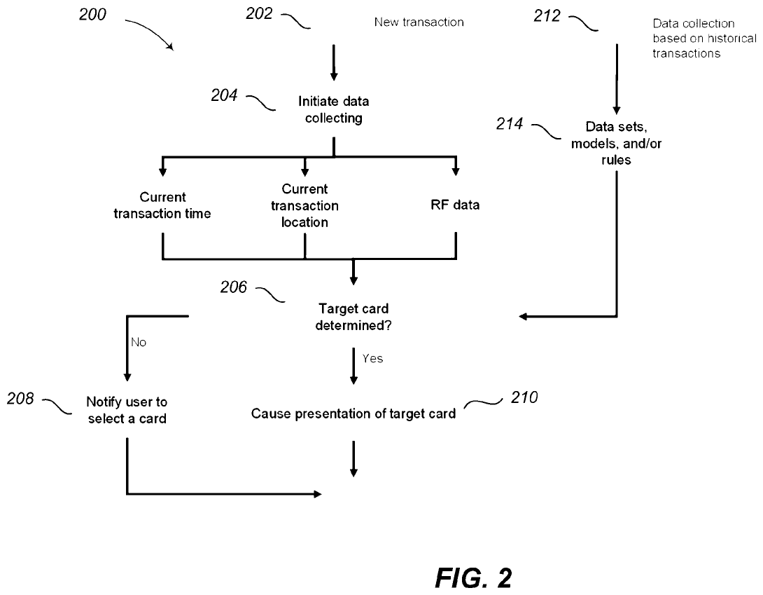

FIG. 2 illustrates a flow diagram of an example process 200 for determining and presenting digital emulated card, in accordance with some embodiments of the presently disclosed technology. Illustratively, the process 200 can be implemented by an NFC device 102, in part or in whole. In some embodiments, at least part of the process 200 is implemented by an NFC device 102 and one or more NFC services 106.

At block 202, the process 200 includes starting a new NFC card transaction. Illustratively, when the NFC device 102 approaches an NFC reader 104, a request for presenting a digital emulated card is generated or received by the NFC device for the new NFC card transaction corresponding to the NFC reader.

At block 204, the process 200 includes initiating collection of data related to the new NFC card transaction. In some embodiments, the NFC device collects at least a current time (e.g., system time of the NFC device, time obtained from an App or service, or the like), a current location of the NFC device, and current radio frequency (RF) data associated with the NFC reader.

In some embodiments, the RF data includes a sequence of commands sent from the NFC reader and intervals between the commands. For example, the NFC device can collect the period (or interval) of each polling loop from the NFC reader if it sends polling event periodically, the period (or interval) between polling commands (e.g., REQ*) that the NFC reader sends, the period (or interval) between select commands (e.g., SEL_REQ) that the NFC reader sends, combination of the same or the like.

As further examples, the RF data can include one or more intervals between pair(s) of commands selected from REQuest command for Type A digital card (REQA), wake up for polling Type A digital card (WUPA), REQuest command for Type B digital card (REQB), wake up for polling Type A digital card (WUPB), ALL_REQ command or SENS_REQ command for NFC-A, ALLB_REQ command or SENSB_REQ command for NFC-B, SENSF_REQ command for NFC-F, INVENTORY_REQ command for NFC-V, or ATR_REQ command for NFC-ACM. The RF data can include intervals between two remote RF field on/off event. The RF data can include the strength of RF field from the NFC reader.

At block 206, the process 200 includes analyzing whether a target emulated card can be determined based, at least in part, on the data collected. The analyzing can include comparison of the collected data with established data set(s), application of trained machine learning model(s) on the collected data, deduction from the collected data based on established rule(s), combination of the same or the like.

At block 208, the process 200 includes, notifying or causing notification to a user of the NFC device to manually select an emulated card for the new NFC card transaction. At block 210, the process 200 includes, causing presentation of the target emulated card to the NFC reader via NFC communication, if the target card is determined. At block 212, the process 200 includes collecting data based on historical NFC card transactions. Illustratively, such data can be collected from transaction records stored locally at the NFC device or collected from one or more third party services (e.g., banks, card authorities, or transaction clearing houses). The data can include the time, location, identification of presented emulated card, and NFC reader RF data associated with successful NFC card transactions (e.g., where the corresponding NFC reader accepts the presented emulated card). In some embodiments, the data collected at block 212 includes or corroborates at least a subset of the data collected at block 204.

As an example, records of time, locations, and UID of an emulated card can be collected. In some embodiments, only records associated with successful transactions are collected. Illustratively, time of successful transactions associated with a same emulated card can be recorded and be used as a factor to predict user habits. Locations of successful transactions has similar effects as time, which can be recorded and used as a factor to predict user habits.

As another example, records of RF commands exchange can be collected.

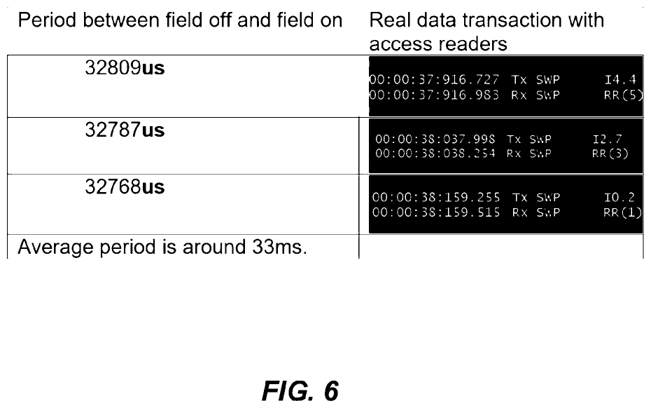

FIG. 6 illustrates the period of each polling loop from a particular NFC reader that sends polling event periodically. The polling loop starts with “remote field on” indicating that the NFC device enters the field of NFC reader, and ends with “remote field off” indicating the NFC device leaves the field of NFC reader. The data shows this particular NFC reader has a polling loop period of around 33 ms, which can be unique for identifying this particular NFC reader and thereby used as a factor for determining a target emulated card for this particular NFC reader.

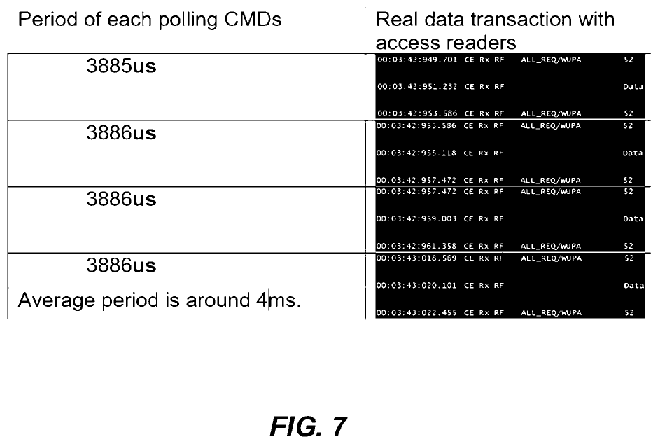

FIG. 7 illustrates the period of each polling command (e.g., “REQ*”) from a particular NFC reader. The data is captured within one polling loop of the NFC reader that sends polling event periodically. As shown, this period is calculated between two polling commands “ALL_REQ(WUPA)” within one polling loop, and it may also be determined by recording the period of different polling loops and computing an average thereof. This period can be unique for identifying this particular NFC reader, and thereby used as a factor for determining a target emulated card for this particular NFC reader.

In some embodiments, some NFC readers can emit different polling commands (e.g., “REQA” and “REQB”) periodically in one polling loop, and some NFC readers only emit one type of polling commands, so the difference in commands paired with their period or interval can be unique to the particular NFC reader and thereby used to further distinguish between NFC readers. The RF data collection can be conducted throughout the entire process when the NFC device is in the field of a reader, when the reader emits a periodical RF carrier.

The collected data can further include historical transaction data within a temporal and/or spatial proximity (e.g., a threshold date/time window and a threshold geographic radius) relative to the time and location of the NFC device associated with successful NFC card transactions. The historical transaction data can be collected while a successful transaction is ongoing or as soon as it is completed. The historical transaction data can provide various contextual information for respective successful transactions that pairs a particular emulated card with a particular NFC card reader, to contribute to relevant data set(s), machine learning model(s), and/or deduction rule(s) for determining target emulated cards.

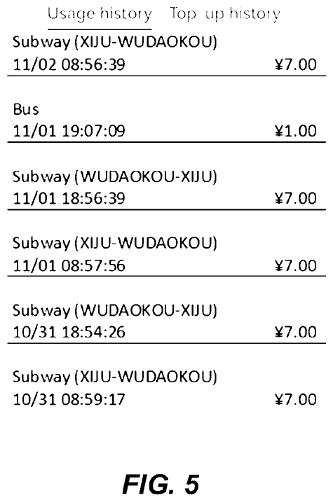

FIG. 5 illustrates an example of historical transaction data. The historical transaction data can include transaction types, such as subway or bus. Illustratively, this information can provide insight into which transaction type(s) the user engages mostly (e.g., subway). The historical transaction data can include locations of departure and destination. This information can provide insight into the spatial trajectory of event(s) leading up to a successful NFC transaction. Use “Subway (XIJU-WUDAOKOU)” as an example, “XIJU” is the departure station and “WUDAOKOU” is the destination station. Similar records such as “XIJU-WUDAOKOU” or “WUDAOKOU-XIJU” appear quite often, which can indicate that “XIJU” and “WUDAOKOU” stations are regular locations where the user take subways. The historical transaction data can include time of transactions, which may or may not be the same as the current time collected (e.g., at block 204) at the beginning of the transaction. This information can provide a basis for time-based prediction. For example, FIG. 5 shows that around 9 am, the user arrives at “WUDAOKOU” station, and based on average subway speed and the distance between stations, a predicted arrival time at “XIJU” station can be determined.

At block 214, the process 200 includes using the data collected at block 212 to generate and/or update the data set(s), machine learning model(s), deduction rule(s), or the like, for determining and presenting proper digital emulated cards. As described above, these data set(s), machine learning model(s), deduction rule(s) can be used at block 206.

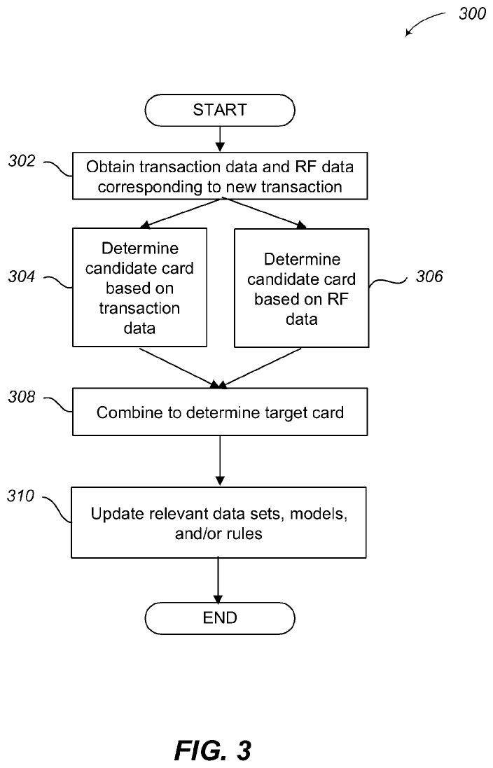

FIG. 3 illustrates a flow diagram of an example process 300 for determining a target emulated card for a new NFC card transaction, in accordance with some embodiments of the presently disclosed technology. Illustratively, the process 300 can be implemented by an NFC device 102, in part or in whole. In some embodiments, at least part of the process 300 is implemented by an NFC device 102 and one or more NFC services 106. In some embodiments, at least part of the process 300 can be a subprocess corresponding to block 206 of process 200.

At block 302, the process 300 includes obtaining transaction data (e.g., current time, current location, historical transaction data within a temporal and/or spatial proximity to the current time and/or location, combination of the same or the like) and current RF data associated with an NFC reader 104 corresponding to the new NFC card transaction. In some embodiments, the historical transaction data is collected responsive to the current time and current location being collected, e.g., at block 204 of process 200.

At block 304, the process 300 includes determining a first candidate digital emulated card from digital emulated cards stored on the NFC device based on the obtained transaction data, e.g., by using at least a subset of the established data set(s), trained machine learning model(s), and/or learned deduction rule(s).

At block 306, the process includes determining a second candidate digital emulated card from the digital emulated cards stored on the NFC device based on the current RF data, e.g., by using at least another subset of the established data set(s), trained machine learning model(s), and/or learned deduction rule(s).

In some embodiments, the determining of the first candidate digital emulated card is performed independently from the determining of the second candidate digital emulated card. In some embodiments, the determining of the first candidate digital emulated card and the determining of the second candidate digital emulated card are performed concurrently, in a manner partially overlapping with each other, or sequentially. At block 308, the process 300 includes determining the target digital emulated card for the new NFC card transaction based on the first and second candidate digital emulated cards. In some embodiments, the first and second candidate digital emulated cards are the same, and the target card is determined to be the same card. In some embodiments, determining the target candidate digital emulated card includes selecting from the first or second candidate digital emulated cards based, at least in part, on respective weights associated with the first and second candidate digital emulated cards.

The weights can be trained or otherwise learned, e.g., from historical selections between the first and second candidates and their associated success rates.

At block 310, the process 300 includes causing update to the relevant data set(s), machine learning model(s), deduction rule(s), weight(s), or the like for determining a digital emulated card from digital emulated cards stored on the NFC device, based on the transaction data and RF data obtained as well as the target digital emulated card determined. In some embodiments, the update is performed responsive to an acceptance of the target digital emulated card by the NFC reader 104.

Those skilled in the art will appreciate that the various operations depicted via FIGS. 2 and 3, as well as those described elsewhere herein, may be altered in a variety of ways. For example, the particular order of the operations may be rearranged; some operations may be performed in parallel; shown operations may be omitted, or other operations may be included; a shown operation may be divided into one or more component operations, or multiple shown operations may be combined into a single operation, etc.

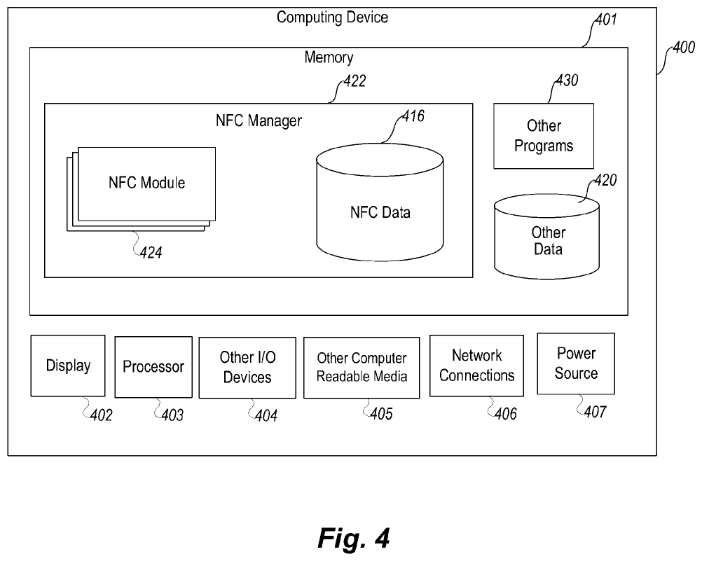

FIG. 4 is a block diagram illustrating elements of an example computing device or system 400 utilized in accordance with some embodiments of the techniques described herein. Illustratively, the computing device 400 corresponds to an NFC device 102, an NFC reader 104, a computing device implementing an NFC service 106, or at least a part thereof.

In some embodiments, one or more general purpose or special purpose computing systems or devices may be used to implement the computing device 400. In addition, in some embodiments, the computing device 400 may comprise one or more distinct computing systems or devices, and may span distributed locations. Furthermore, each block shown in FIG. 4 may represent one or more such blocks as appropriate to a specific embodiment or may be combined with other blocks. Also, the NFC manager 422 may be implemented in software, hardware, firmware, or in some combination to achieve the capabilities described herein.

As shown, the computing device 400 comprises a computer memory (“memory”) 401, a display 402 (including, but not limited to a light emitting diode (LED) panel, cathode ray tube (CRT) display, liquid crystal display (LCD), touch screen display, projector, etc.), one or more Central Processing Units (CPU) or other processors 403, Input/Output (I/O) devices 404 (e.g., keyboard, mouse, RF or infrared receiver, universal serial bus (USB) ports, High-Definition Multimedia Interface (HDMI) ports, other communication ports, and the like), other computer-readable media 405, network connections 406, a power source (or interface to a power source) 407. The NFC manager 422 is shown residing in memory 401. In other embodiments, some portion of the contents and some, or all, of the components of the NFC manager 422 may be stored on and/or transmitted over the other computer-readable media 405. The components of the computing device 400 and NFC manager 422 can execute on one or more processors 403 and implement applicable functions described herein. In some embodiments, the NFC manager 422 may operate as, be part of, or work in conjunction and/or cooperation with other software applications stored in memory 401 or on various other computing devices. In some embodiments, the NFC manager 422 also facilitates communication with peripheral devices via the I/O devices 404, or with another device or system via the network connections 406.

The one or more NFC modules 424 is configured to perform actions related, directly or indirectly, to the determining and presenting of digital emulated cards as described herein. In some embodiments, the NFC module(s) 424 stores, retrieves, or otherwise accesses at least some NFC-related data on some portion of the NFC data storage 416 or other data storage internal or external to the computing device 400. In various embodiments, at least some of the NFC modules 424 may be implemented in software or hardware.

Other code or programs 430 (e.g., further data processing modules, communication modules, a Web server, and the like), and potentially other data repositories, such as data repository 420 for storing other data, may also reside in the memory 401, and can execute on one or more processors 403. Of note, one or more of the components in FIG. 4 may or may not be present in any specific implementation. For example, some embodiments may not provide other computer readable media 405 or a display 402.

In some embodiments, the computing device 400 and NFC manager 422 include API(s) that provides programmatic access to add, remove, or change one or more functions of the computing device 400. In some embodiments, components/modules of the computing device 400 and NFC manager 422 are implemented using standard programming techniques. For example, the NFC manager 422 may be implemented as an executable running on the processor(s) 403, along with one or more static or dynamic libraries. In other embodiments, the computing device 400 and NFC manager 422 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic. NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the computing device 400 to perform the functions of the NFC manager 422. In some embodiments, instructions cause the one or more processors 403 or some other processor(s), such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a NFC manager 422 implementation. Also, other functions could be implemented and/or performed by each component/module, and in different orders, and by different components/modules, yet still achieve the functions of the computing device 400 and NFC manager 422.

In addition, programming interfaces to the data stored as part of the computing device 400 and NFC manager 422, can be available by standard mechanisms such as through C, C++, C#, and Java APIs; libraries for accessing files, databases, or other data repositories; scripting languages such as XML; or Web servers, FTP servers, NFS file servers, or other types of servers providing access to stored data. The NFC data storage 416 and data repository 420 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the NFC manager 422.

Furthermore, in some embodiments, some or all of the components of the computing device 400 and NFC manager 422 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

In some embodiments, a method includes: responsive to a request for presenting a digital emulated card, collecting, by a near field communication (NFC) device, a current time, a current location of the NFC device, and current radio frequency (RF) data associated with an NFC reader; determining a first candidate digital emulated card from a plurality of digital emulated cards stored on the NFC device based, at least in part, on the current time and current location; determining a second candidate digital emulated card from the plurality of digital emulated cards based, at least in part, on the current RF data; determining a target digital emulated card based, at least in part, on the first and second candidate digital emulated cards; and presenting, by the NFC device, the target digital emulated card to the NFC reader via NFC communication.

In some embodiments, the determining of the first candidate digital emulated card is performed independently from the determining of the second candidate digital emulated card.

In some embodiments, the determining of the first candidate digital emulated card and the determining of the second candidate digital emulated card are performed concurrently, partially overlapping with each other, or sequentially.

In some embodiments, the determining of the first candidate digital emulated card is based, at least in part, on historical transaction data within a temporal and spatial proximity of the current time and current location. In some embodiments, the method includes collecting the historical transaction data responsive to the current time and current location being collected.

In some embodiments, determining the target candidate digital emulated card comprises selecting from the first or second candidate digital emulated cards based, at least in part, on respective weights associated with the first and second candidate digital emulated cards.

In some embodiments, determining the target candidate digital emulated card includes: responsive to determining that the first and second candidate digital emulated cards are a same candidate digital emulated card, determining the target candidate digital emulated card as the same candidate digital emulated card.

In some embodiments, the RF data includes a sequence of commands from the NFC reader and intervals between the commands. In some embodiments, the commands include one or more polling commands.

In some embodiments, the method includes: responsive to an acceptance of the target digital emulated card by the NFC reader, causing update to one or more data sets, machine learning models, or deduction rules for determining a digital emulated card from a plurality of digital emulated cards stored on the NFC device based, at least in part, on the current time, current location, current RF data, and target digital emulated card.

In some embodiments, an NFC device includes one or more processors; and memory storing contents that, when executed by the one or more processors, cause the NFC device to perform actions. The actions include: responsive to a request for presenting a digital emulated card, collecting a current time, a current location of the NFC device, and current radio frequency (RF) data associated with an NFC reader; determining a first candidate digital emulated card from a plurality of digital emulated cards stored on the NFC device based, at least in part, on the current time and current location; determining a second candidate digital emulated card from the plurality of digital emulated cards based, at least in part, on the current RF data; determining a target digital emulated card based, at least in part, on the first and second candidate digital emulated cards; and presenting the target digital emulated card to the NFC reader via NFC communication.

In some embodiments, the determining of the first candidate digital emulated card is performed independently from the determining of the second candidate digital emulated card.

In some embodiments, the determining of the first candidate digital emulated card and the determining of the second candidate digital emulated card are performed concurrently, partially overlapping with each other, or sequentially.

In some embodiments, the determining of the first candidate digital emulated card is based, at least in part, on historical transaction data within a temporal and spatial proximity of the current time and current location. In some embodiments, the actions include collecting the historical transaction data responsive to the current time and current location being collected.

In some embodiments, determining the target candidate digital emulated card comprises selecting from the first or second candidate digital emulated cards based, at least in part, on respective weights associated with the first and second candidate digital emulated cards.

In some embodiments, determining the target candidate digital emulated card includes: responsive to determining that the first and second candidate digital emulated cards are a same candidate digital emulated card, determining the target candidate digital emulated card as the same candidate digital emulated card.

In some embodiments, the RF data includes a sequence of commands from the NFC reader and intervals between the commands. In some embodiments, the commands include one or more polling commands.

In some embodiments, the actions include: responsive to an acceptance of the target digital emulated card by the NFC reader, causing update to one or more data sets, machine learning models, or deduction rules for determining a digital emulated card from a plurality of digital emulated cards stored on the NFC device based, at least in part, on the current time, current location, current RF data, and target digital emulated card.

In some embodiments, a non-transitory computer-readable medium stores contents that cause one or more processors to perform actions. The actions include: responsive to a request for presenting a digital emulated card, collecting, by a near field communication (NFC) device, a current time, a current location of the NFC device, and current radio frequency (RF) data associated with an NFC reader; determining a first candidate digital emulated card from a plurality of digital emulated cards stored on the NFC device based, at least in part, on the current time and current location; determining a second candidate digital emulated card from the plurality of digital emulated cards based, at least in part, on the current RF data; determining a target digital emulated card based, at least in part, on the first and second candidate digital emulated cards; and presenting, by the NFC device, the target digital emulated card to the NFC reader via NFC communication.

In some embodiments, the determining of the first candidate digital emulated card is performed independently from the determining of the second candidate digital emulated card.

In some embodiments, the determining of the first candidate digital emulated card and the determining of the second candidate digital emulated card are performed concurrently, partially overlapping with each other, or sequentially.

In some embodiments, the determining of the first candidate digital emulated card is based, at least in part, on historical transaction data within a temporal and spatial proximity of the current time and current location. In some embodiments, the actions include collecting the historical transaction data responsive to the current time and current location being collected.

In some embodiments, determining the target candidate digital emulated card includes selecting from the first or second candidate digital emulated cards based, at least in part, on respective weights associated with the first and second candidate digital emulated cards.

In some embodiments, determining the target candidate digital emulated card includes: responsive to determining that the first and second candidate digital emulated cards are a same candidate digital emulated card, determining the target candidate digital emulated card as the same candidate digital emulated card.

In some embodiments, the RF data includes a sequence of commands from the NFC reader and intervals between the commands. In some embodiments, the commands include one or more polling commands.

In some embodiments, the actions include: responsive to an acceptance of the target digital emulated card by the NFC reader, causing update to one or more data sets, machine learning models, or deduction rules for determining a digital emulated card from a plurality of digital emulated cards stored on the NFC device based, at least in part, on the current time, current location, current RF data, and target digital emulated card.

In some embodiments, an NFC system includes one or more host processors, and an NFC device coupled to the one or more host processors and configured to perform actions. The actions include: responsive to a request for presenting a digital emulated card, collecting a current time, a current location of the NFC device, and current radio frequency (RF) data associated with an NFC reader; determining a first candidate digital emulated card from a plurality of digital emulated cards stored on the NFC device based, at least in part, on the current time and current location; determining a second candidate digital emulated card from the plurality of digital emulated cards based, at least in part, on the current RF data; determining a target digital emulated card based, at least in part, on the first and second candidate digital emulated cards; and presenting the target digital emulated card to the NFC reader via NFC communication.

In some embodiments, the determining of the first candidate digital emulated card is performed independently from the determining of the second candidate digital emulated card.

In some embodiments, the determining of the first candidate digital emulated card and the determining of the second candidate digital emulated card are performed concurrently, partially overlapping with each other, or sequentially.

In some embodiments, the determining of the first candidate digital emulated card is based, at least in part, on historical transaction data within a temporal and spatial proximity of the current time and current location. In some embodiments, the actions include collecting the historical transaction data responsive to the current time and current location being collected.

In some embodiments, determining the target candidate digital emulated card comprises selecting from the first or second candidate digital emulated cards based, at least in part, on respective weights associated with the first and second candidate digital emulated cards.

In some embodiments, determining the target candidate digital emulated card includes: responsive to determining that the first and second candidate digital emulated cards are a same candidate digital emulated card, determining the target candidate digital emulated card as the same candidate digital emulated card.

In some embodiments, the RF data includes a sequence of commands from the NFC reader and intervals between the commands. In some embodiments, the commands include one or more polling commands.

In some embodiments, the actions include: responsive to an acceptance of the target digital emulated card by the NFC reader, causing update to one or more data sets, machine learning models, or deduction rules for determining a digital emulated card from a plurality of digital emulated cards stored on the NFC device based, at least in part, on the current time, current location, current RF data, and target digital emulated card.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
responsive to a request for presenting a digital emulated card, collecting, by a near field communication (NFC) device, a current time, a current location of the NFC device, and current radio frequency (RF) data associated with an NFC reader;
determining a first candidate digital emulated card from a plurality of digital emulated cards stored on the NFC device based, at least in part, on the current time and current location;
determining a second candidate digital emulated card from the plurality of digital emulated cards based, at least in part, on the current RF data;
determining a target digital emulated card based, at least in part, on the first and second candidate digital emulated cards; and
presenting, by the NFC device, the target digital emulated card to the NFC reader via NFC communication.

2. The method of claim 1, wherein the determining of the first candidate digital emulated card is performed independently from the determining of the second candidate digital emulated card.

3. The method of claim 1, wherein the determining of the first candidate digital emulated card and the determining of the second candidate digital emulated card are performed concurrently, partially overlapping with each other, or sequentially.

4. The method of claim 1, wherein the determining of the first candidate digital emulated card is based, at least in part, on historical transaction data within a temporal and spatial proximity of the current time and current location.

5. The method of claim 4, comprising collecting the historical transaction data responsive to the current time and current location being collected.

6. The method of claim 1, wherein determining the target candidate digital emulated card comprises selecting from the first or second candidate digital emulated cards based, at least in part, on respective weights associated with the first and second candidate digital emulated cards.

7. The method of claim 1, wherein determining the target candidate digital emulated card comprises: responsive to determining that the first and second candidate digital emulated cards are a same candidate digital emulated card, determining the target candidate digital emulated card as the same candidate digital emulated card.

8. The method of claim 1, wherein the RF data includes a sequence of commands from the NFC reader and intervals between the commands.

9. The method of claim 8, wherein the commands include one or more polling commands.

10. The method of claim 1, comprising: responsive to an acceptance of the target digital emulated card by the NFC reader, causing update to one or more data sets, machine learning models, or deduction rules for determining a digital emulated card from a plurality of digital emulated cards stored on the NFC device based, at least in part, on the current time, current location, current RF data, and target digital emulated card.

11. An NFC device, comprising:
one or more processors; and
memory storing contents that, when executed by the one or more processors, cause the NFC device to perform actions comprising:
responsive to a request for presenting a digital emulated card, collecting a current time, a current location of the NFC device, and current radio frequency (RF) data associated with an NFC reader;
determining a first candidate digital emulated card from a plurality of digital emulated cards stored on the NFC device based, at least in part, on the current time and current location;
determining a second candidate digital emulated card from the plurality of digital emulated cards based, at least in part, on the current RF data;
determining a target digital emulated card based, at least in part, on the first and second candidate digital emulated cards; and
presenting the target digital emulated card to the NFC reader via NFC communication.

12. The NFC device of claim 11, wherein the determining of the first candidate digital emulated card is performed independently from the determining of the second candidate digital emulated card.

13. The NFC device of claim 11, wherein the determining of the first candidate digital emulated card and the determining of the second candidate digital emulated card are performed concurrently, partially overlapping with each other, or sequentially.

14. The NFC device of claim 11, wherein the determining of the first candidate digital emulated card is based, at least in part, on historical transaction data within a temporal and spatial proximity of the current time and current location.

15. The NFC device of claim 14, wherein the actions comprise collecting the historical transaction data responsive to the current time and current location being collected.

16-20. (canceled)

21. A non-transitory computer-readable medium storing contents that cause one or more processors to perform actions comprising:
responsive to a request for presenting a digital emulated card, collecting, by a near field communication (NFC) device, a current time, a current location of the NFC device, and current radio frequency (RF) data associated with an NFC reader;
determining a first candidate digital emulated card from a plurality of digital emulated cards stored on the NFC device based, at least in part, on the current time and current location;
determining a second candidate digital emulated card from the plurality of digital emulated cards based, at least in part, on the current RF data;
determining a target digital emulated card based, at least in part, on the first and second candidate digital emulated cards; and
presenting, by the NFC device, the target digital emulated card to the NFC reader via NFC communication.

22-25. (canceled)

26. The computer-readable medium of claim 21, wherein determining the target candidate digital emulated card comprises selecting from the first or second candidate digital emulated cards based, at least in part, on respective weights associated with the first and second candidate digital emulated cards.

27. The computer-readable medium of claim 21, wherein determining the target candidate digital emulated card comprises: responsive to determining that the first and second candidate digital emulated cards are a same candidate digital emulated card, determining the target candidate digital emulated card as the same candidate digital emulated card.

28. The computer-readable medium of claim 21, wherein the RF data includes a sequence of commands from the NFC reader and intervals between the commands.

29. (canceled)

30. The computer-readable medium of claim 21, wherein the actions comprise: responsive to an acceptance of the target digital emulated card by the NFC reader, causing update to one or more data sets, machine learning models, or deduction rules for determining a digital emulated card from a plurality of digital emulated cards stored on the NFC device based, at least in part, on the current time, current location, current RF data, and target digital emulated card.

31-40. (canceled)
